(19) United States
(12) Patent Application Publication
(10) Pub. No.: US 2002/0053780 A1
(43) Pub. Date: May 9, 2002

(54) Bicycle

(76) Inventors: Nicholas A. Weisz, London (GB); Alan C. Saxby, Putney, VT (US)

Correspondence Address: Price, Heneveld, Cooper, DeWitt & Litton, 695 Kenmoor, S.E., Post Office Box 2567, Grand Rapids, MI, 49501, US

(21) Appl. No.: 09/849,175

(22) Filed: May 4, 2001

Related U.S. Application Data
(63) Continuation of application No. PCT/GB99/03672, filed on Nov. 5, 1999.

(30) Foreign Application Priority Data
Nov. 6, 1998 (GB) 9824440.3

(51) Int. Cl. B62K 15/00

(52) U.S. Cl. 280/287

(57) ABSTRACT

A folding bicycle includes telescoping handle bar and seat posts provided at a divergent angle so as to give a range of possible reaches for the user. In addition, the bicycle is configured such that when it is folded, the front and rear wheels are adjacent one another with the handle bars projecting substantially above such that the trolley can further be used to trolley luggage using suitable means for retaining the bicycle in the folded position. Yet further the bicycle configuration is selected for optimum handling and braking ability.

### CROSS-REFERENCE TO RELATED APPLICATIONS

This application is a continuation of PCT International Application No. PCT/GB99/03672 filed in Great Britain on Nov. 5, 1999 designating the United States of America and published in English on May 18, 2000, which claims priority to British Patent Application No. 9824440.3 filed Sep. Nov. 6, 1998.

### BACKGROUND OF THE INVENTION

The present invention relates to a bicycle, in particular a portable, foldable or adjustable bicycle.

A portable bicycle typically used hinges and/or structures which slide inside each other. These allow folding or reduction of size of the frame and other elements of the bicycle. This reduces the size of the bicycle while storing it, carrying it or using it in conjunction with other forms of transport.

Therefore, the principal rationale of a folding bicycle is enhanced utility and versatility. Such utility and versatility would be greatly enhanced if the folding bicycle could carry adequate luggage when it is folded and the bicycle could be trolleyed along with the luggage held securely on the bicycle. This feature can be invaluable along with the luggage held securely on the bicycle. This feature can also be invaluable when a commuter is faced with a restriction on wheeling along an unfolded bicycle through a large railway station platform. The worst aspect of folding bicycle designs is the need to remove the luggage off the rear carrier of the bicycle prior to folding and the subsequent carrying of the luggage and folded bicycle separately. This situation is not ameliorated by designs as described in U.S. Pat. No. 4,182,522 which can be trolleyed on small wheels attached to its rear carrier when the bicycle is folded—the luggage has still to be removed and carried separately. Other designs such as described in U.S. Pat. No. 4,718,688 can be effectively trolleyed, but do not have the ability to use it simultaneously as a luggage trolley.

The rationale of a folding bicycle's design is further enhanced if one bicycle can be made to adjust to fit people of different sizes. This feature would make maximum use of the compactness of the folded bicycle—instead of needing to store, e.g. 3 rigid, full size bicycles for 3 different size people, one compact folded bicycle should ideally fit everyone.

A known bicycle uses a fixed handlebar position but an angled seatpost which diverges from the handlebar angle. The limitation of this system is that it gives the correct, efficient pedaling position (i.e. where maximum torque is applied with the pedals near a horizontal position) for only a limited range of size of rider; weight distribution of the rider makes the bike unstable above a limited range of adjustment.

### SUMMARY OF THE INVENTION

Accordingly, in a first aspect, the present invention provides a bicycle as set out in claim 1. Thus, in accordance with the invention, as posts are extended in size for a larger user, the handlebars are automatically positioned further from the seat to compensate for the longer reach of the user.

In a further aspect, the invention provides a folding bicycle as set out in claim 7. As a result, the bicycle in its folded condition automatically and reliably acts as a trolley, without the user even having to unload the luggage from the platform. Furthermore, the handlebars can be used to steer the trolley and even the brakes, lights and bell can be used. In accordance with the invention, the bicycle can be held together in the folded position by a clip as set out in claim 9.

The invention further comprises a folding bicycle as set out in claim 10 and a clamp means as set out in claim 12. The integrity of the clamps securing the hinges on folding bicycles is essential for safe use and minimizing adverse handling effects from flexure. Known systems rely on quick release screw-held systems, which suffer from wear and the need for regular adjustment; the arrangement of the invention compensates for wear automatically and hence overcomes these problems.

The invention further comprises a folding bicycle as set out in claim 13. This arrangement allows the fold sequence to be followed out consistently and correctly.

The invention further provides a seat or handlebar post as set out in claim 14 or 17 allowing consistent and accurate positioning of the post both in terms of height and orientation.

In a further and preferred form of the invention, the handlebar mount may be formed as two tubes slidable one within the other, and means for adjustably locking the tubes in a selected position, wherein the arrangement is such that the handlebars may be twisted through an angle of 180° in order to provide a further distancing of the handlebars from the saddle.

As preferred, the angling of the handlebar mount relative to the vertical is defined by a releasable joint coupling the shaft to the front frame tube, the releasable joint being provided for folding the handlebar mount to a position adjacent to the front wheel. The handlebar mount is preferably welded to a mounting plate forming a pivot arm of the releasable joint.

Further aspects and preferred features of the invention are set out in claims 22 to 26.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a side view showing the bicycle according to the invention in an assembled condition for riding;

FIGS. 2a and 2b are detailed views of the seat post and its mounting within a rear frame seat tube;

FIGS. 3a and 3b are detailed vies of the handlebar post formed as an extendable assembly;

FIGS. 4a to 4d are views of a clamp means for the extendable handlebar or frame beam;

FIGS. 5a and 5b are views of a releasable locking mechanism for holding the folded frame parts of the bicycle together when the bicycle is used as a trolley;

FIG. 6 is a schematic view of the bicycle in a folded condition when used as a trolley;

FIG. 7a is a plan view of a hinge assembly in open configuration according to the present invention;

FIG. 7b is a side view of the hinge assembly of FIG. 7a;

FIG. 7c is a plan view of the locking collar used in the hinge assembly of FIG. 7a;

FIG. 8 shows an improved stem base locking assembly;

FIG. 9a is a front view of a leaf spring assembly for locating the seat of handlebar posts in desired positions;

FIG. 9b is a side view of the spring FIG. 9a;

FIG. 10 shows a possible decal system according to the present invention;

FIG. 11a is a side view of a rear carrier configuration according to the present invention;

FIG. 11b is a plan view of the rear carrier of FIG. 11a;

FIG. 11c shows a detail of the elastic strap used in the rear carrier of FIGS. 11a and 11b; and

FIG. 12 shows a front carrier arrangement according to the present invention.

### DETAILED DESCRIPTION OF THE PREFERRED EMBODIMENT

Referring to FIG. 1, the basic components of the bicycle 100 are shown. The bicycle includes front and rear frame parts 102, 104 bearing respective front 106 and rear 108 wheels and including a hinged frame beam 110. The seat post 112 is telescopically mounted in a mount or tube. The handlebar post 114 is similarly telescopically mounted in a mount 116 or stembase, comprising a tube.

The seatpost and handlebar posts are provided in a “springy” heat treated 1 mm thick chrome molybdenum steel. Ergonomic research has shown that discomfort and tiredness follow from remaining in a fixed riding position. The springiness of these 2 posts ensures the rider's position alters slightly as he/she rides reducing comfort. The springiness also has a suspension effect reducing the transmission of road shock, thus increasing rider comfort. Furthermore, for such long posts subjected to heavy loads (the rider's weight bounding up and down and loads under braking), a steel alloy offers a safer rate of failure, tending to deform if subjected to too high a load rather than fail catastrophically. Aluminum posts favored by many manufacturers of folding bicycles are less suitable given the amount of flexure involved and which makes them subject to possible failure from fatigue.

The combination of a stiff base structure and appropriately flexible telescopic parts provides an inherent suspension system providing a high degree of comfort for the user combined with a long working life.

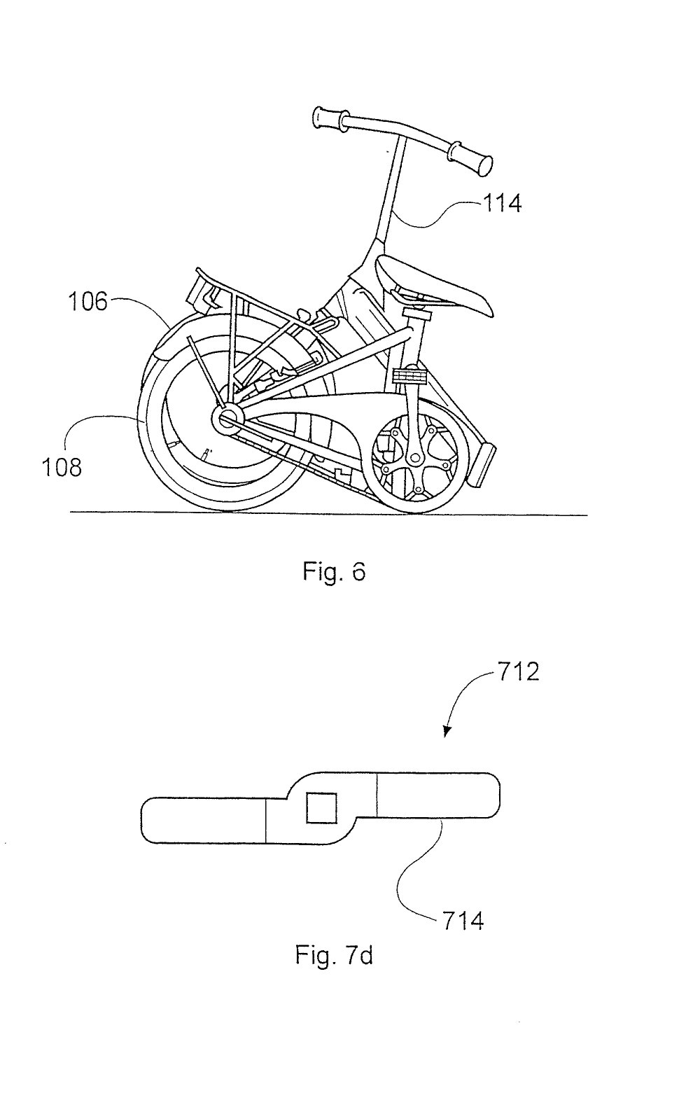

As a result, there is provided a bicycle with a center folding frame whereby when the frame is folded in half, the front and rear wheels will be in substantial alignment with each other and the folded bicycle will sit on a combination of its 2 wheels and the base of the seatpost, as shown in FIG. 6. The telescopic handlebar stem allows height adjustment to make the trolley comfortable to maneuver regardless of the height of the person operating the trolley. The handlebars control the trolley as it is pushed forward with brake controls and bell mounted on the handlebars. A tire operated dynamo lighting system can illuminate the lights when the trolley is pushed. To provide illumination and safety warning while pushing the trolley at night, the headlamp should be mounted on the telescopic handlebar stem assembly and rear light beneath the carrier; this also clears the front folk mount to allow the luggage to sit more securely. A grip portion is preferably provided optimally placed at or near the center of balance of the bicycle in the folded position, for ease and comfort of carrying.

A wide luggage carrier platform is mounted on the rear seat stay tubes of the frame. Such platform begins sufficiently backward from the seatpost so as to minimize the chances of the feet of larger cyclists colliding with the luggage on the carrier while pedaling. The luggage on the rear carrier will have a low center of gravity for easy maneuvering of the loaded trolley.

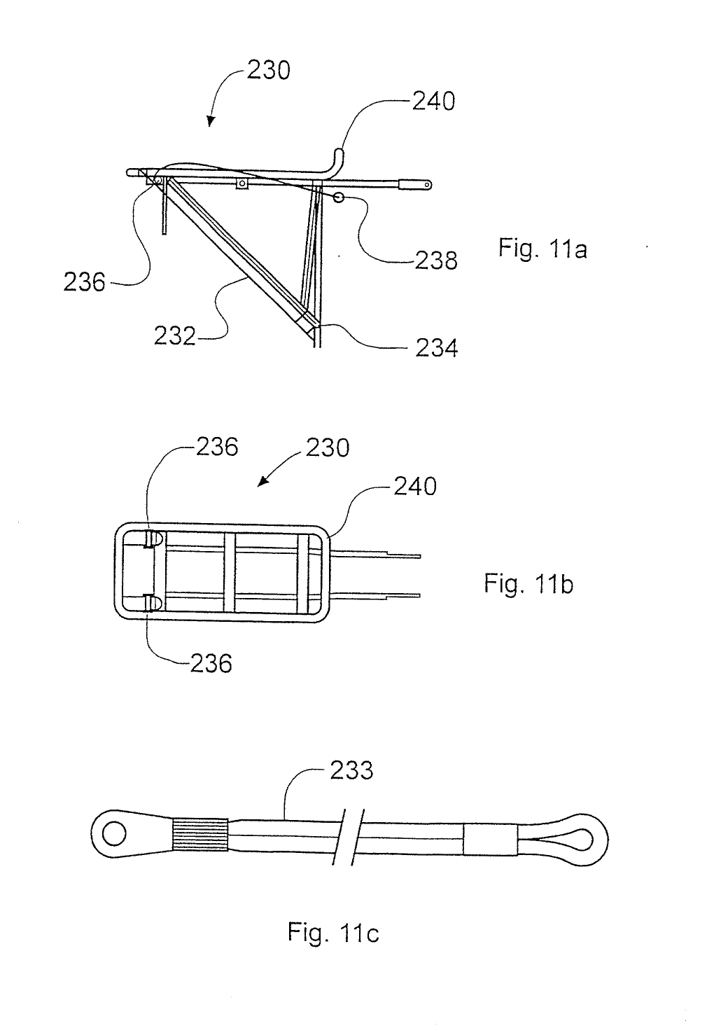

In an alternative, preferred embodiment as shown in FIGS. 11a and 11b, associated with the rear carrying basket 230 is an elasticated strap 232 which leads from near the rear axle shown at 234 to pairs of rollers 236 at the rear and underside of the carrying basket, and over these to an anchor point 238 on the seat post in the vicinity of the foremost point of the carrying basket. The carrying basket also includes a front lip 240 against which luggage can be secured. As a result of the length of the elastic strap 232, a considerable range of sizes of package can be accommodated. This is particularly because the strap passes between each pair of rollers 236 such that one roller is forward of the strip and one (not shown) to the rear. As a result, the appropriate roller is engaged whether the strap is pulled forwardly or rearwardly. A smaller size package can simply be inserted under the part of the strap extending between the rollers 236 and anchor point 238. A larger package can be accommodated by detaching the strap from the anchor point 238, placing the package on the rear carrying basket and looping the elastic strap 232 around the rear one of the roller pair and over the top of the package and re-anchoring it at the point 238. The rollers 236 are of general use in reducing or eliminating abrasion of the elastic strap. In either case, the lip 240 serves to locate the front edge of the package securely. As shown in FIG. 11c, the strap 232 is preferably doubled lengthwise and includes a flexible sleeve adjacent one end allowing the size of the loop at the end detachable from the anchor point 238, to be adjusted to loosen or tighten the attachment.

In addition, as shown in FIG. 12, a front carrier can also be provided. As is known, the front carrier is mounted on a post 114 via a pair of dowels at differing heights 150,152. The carrier includes a locking bar 154 which is of an S-shape and passes around and between the dowels 150,152. The front carrier further includes a forward projection 156 for loading extending substantially horizontally forwardly from the upper end of the locking bar 154. In known systems, the distal end of the projecting portion 156 is secured, for example by elastic, to a suitable anchor point for example at the axle of the front wheel. However, this makes fitting and removal of the carrier problematic. In the embodiment shown in FIG. 12, the locking bar 154 is releasably secured to the dowels 150, 152 by an appropriate means. For example, the dowels can include an overlying disk 151, 153 which secures the locking bar against the post 114. Any other appropriate means can be selected but it will be appreciated that a simple half or full twist arrangement to lock and unlock the bar is preferred for ease of use. In addition, the bar may be pivotally secured to the lower dowel 150. As a result, the front carrier can be moved into and out of position quickly and easily by releasing one or both of the disks 151, 153. This can be particularly useful when the bicycle is moved to the folded position in which case it may be desired to move the front carrier out of the way if the rear carrier is loaded.

To provide a secure trolley configuration, a clip system 500 shown in FIG. 5 secures the front forks and the rear section of the frame together when the bicycle is folded in half. The clip system enables the half folded bicycle to perform as a stable trolley and its location is determined by the need to minimize the leverage applied to it. The clip system must be capable of withstanding the considerable lateral loads involved while trolleying heavy weights on the rear carrier, yet it must still be capable of being clipped together and unclipped together without the need for undue force. In the example shown, the tendency of the barrel connection on the front fork is to move with the fork in an arc relative to the female half 502 of the clip. This will lead to the clip springing open when trolleying. This arc motion is controlled by 2 hard plastic disks 504 molded as part of the male barrel connection 506 which are a flush fit over the ends of the female part of the clip. In addition, a thumb pad can be provided on the rear luggage carrier to make disengagement from the folded position comfortable and easy, and to direct the user to position his or her hand on the optimum position to carry out the operation. As discussed in more detail below, the frame design must incorporate the choice of steering head angle in conjunction with wheelbase, chainstay length and main frame beam length, preferably to ensure that the steering head lines up with, or at least behind the bracket on the rear luggage carrier in the folded condition, for optimum positioning of the luggage bearing aspect.

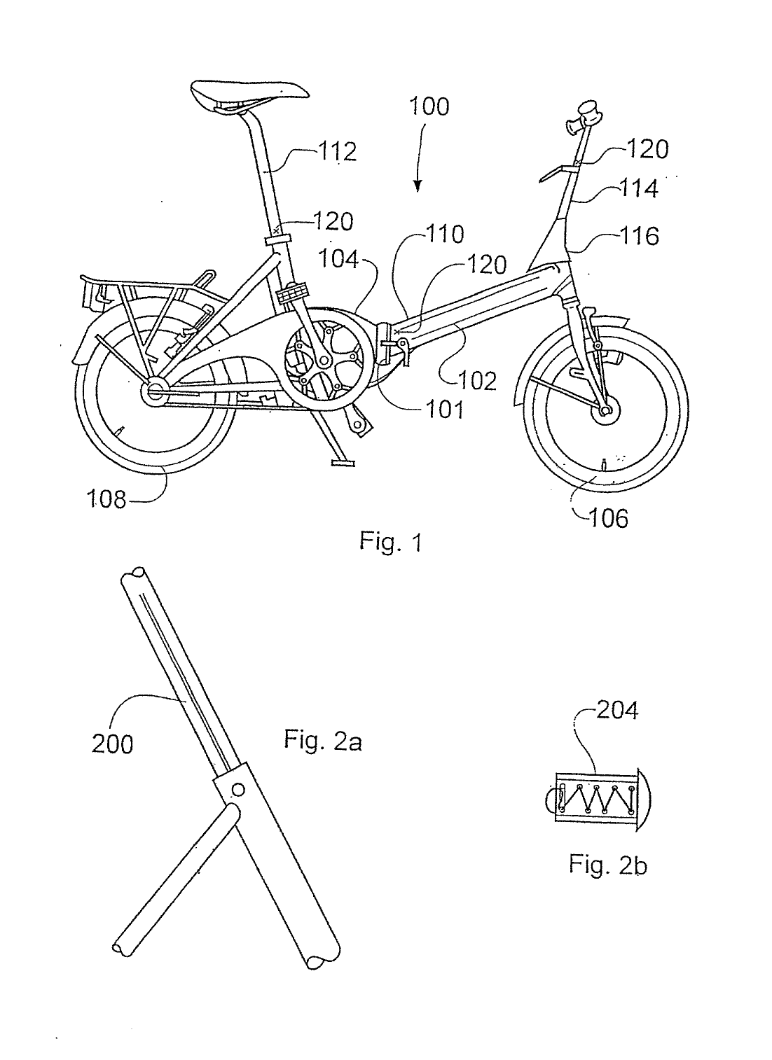

As shown in FIG. 2, an easy select system for both the handlebar post and seatpost 200 is used. Enhanced adjustability is only effective if the preferred positions can be easily and accurately selected. The easy select system ensures the accurate reselection of the correct height of the seatpost and handlebar post for the individual rider. It also ensures that the handlebars are correctly set at 90° to the main frame of the bicycle when the front wheel is pointing directly ahead and that the saddle is in alignment with the main frame. In this example, this involves using 2 grooved lines 202 on either side of both posts at 180° gaps. A spring loaded ball bearing 204 located in the seat tube and one in the handlebar stem base will positively ensure the correct location of the posts when the ball aligns with the groove.

According to a preferred embodiment, the plunger is replaced by a leaf spring which again is discussed with reference equally to the seat post and handlebar post. Referring to FIGS. 9a and 9b, a leaf spring 210 comprises a strip of resilient material of generally U-shaped configuration but with one limb shorter than the other. The shorter limb carries a detent in the form, for example, of a hemispherical projection 212 shaped to mate with the groove with no play, such that precise fixed alignment is achieved. In the preferred embodiment, the leaf spring is secured to the outside to the seat post or handlebar post via screws engaging apertures 214 in the leaf spring. An aperture (not shown) is provided suitably positioned on the seat post or handlebar post through which the leaf spring and detent 212 project to engage the groove in the seat post. The screw holes on the leaf spring are formed as slots allowing the exact position of the leaf spring to be determined by adjustment before the screws are tightened. In addition, the post aperture is large enough to accommodate movement of the leaf spring during the adjustment. As a result, manufacturing tolerances are greater as precise alignment is achieved during assembly. The groove itself is preferably formed with angled sides and radiused corners to minimize user effort but at the same time provide a tangible locking and unlocking sensation as the detent engages and disengages. In addition, the detent is of suitable dimension not to contact the rear face of the groove such that decals on that face are not abraded or worn as the detent slides up and down inside the groove.

In addition, in relation to the handlebar post, preferably there are provided first and second springs which may be approximately 90° to one another. The first spring is for fixing the handlebars at the correct riding orientation. The second spring fixes the handlebars in the ideal position for folding. Previously this position would have been located simply by folding the handlebars down and adjusting the orientation until the optimum position was obtained, however, according to this aspect of the invention, it is now possible to rotate the handlebars automatically between the riding position and the folded position with minimum difficulty. Particular advantages of the leaf spring are its precision and long life. In particular, the spring is designed to withstand up and down sliding and rotation actions without affecting the smooth telescoping action of the post itself. Furthermore, realignment of the spring is possible, and the reduced number of parts and simplicity of the parts reduce the risks of water contamination and corrosion.

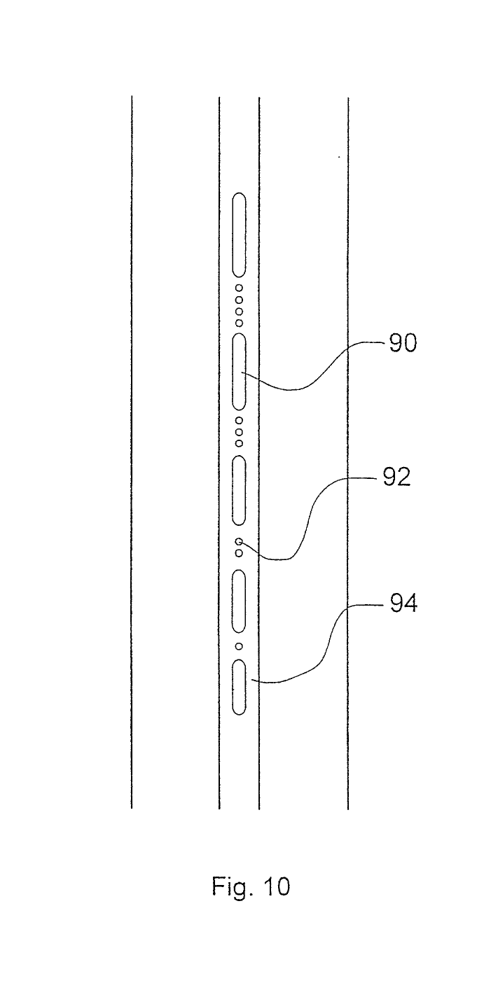

Markings in the base of the groove which may be colored to enhance visibility will indicate the different height settings. By locating these markings in the base of the grooves, the ball bearing will not come into contact with them and therefore the markings will not be rubbed away. Referring now to FIG. 10, one proposed marking system is shown. In particular, a plurality of elongate marks 90 are separated by one or more shorter marks 92, the number of shorter marks increasing sequentially for each longer mark. The marks are provided at the bottom of the groove 94 to avoid abrasion. As a result, a simple and easily memorable system is provided in which the user can immediately recall amongst which of the groupings of smaller marks, the preferred height is to be found, and subsequently which amongst those marks is the most appropriate one.

The use of a rubber stop with a curved radius in the base of the seatpost positively located by the end of the vertical grooves in the side of the post enhances stability of the folded bicycle and allows the saddle of the folded bicycle to be used as a seat while waiting for a train, etc.

An effective mnemonic system is also preferred for remembering the fold sequence etc. and therefore for ensuring that the sequence is followed so that the bicycle is in the correct safe position when it is used as a trolley. In this example, as shown in FIG. 1, numbers 120 are located next to each clamp indicating the order of operating the clamps to ensure the correct sequence of folding the bicycle.

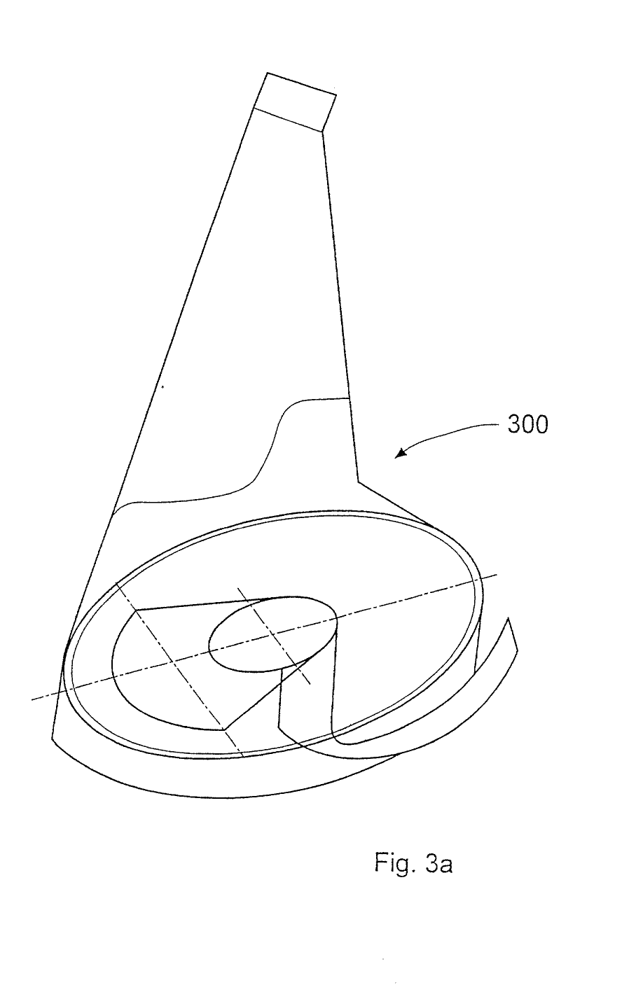

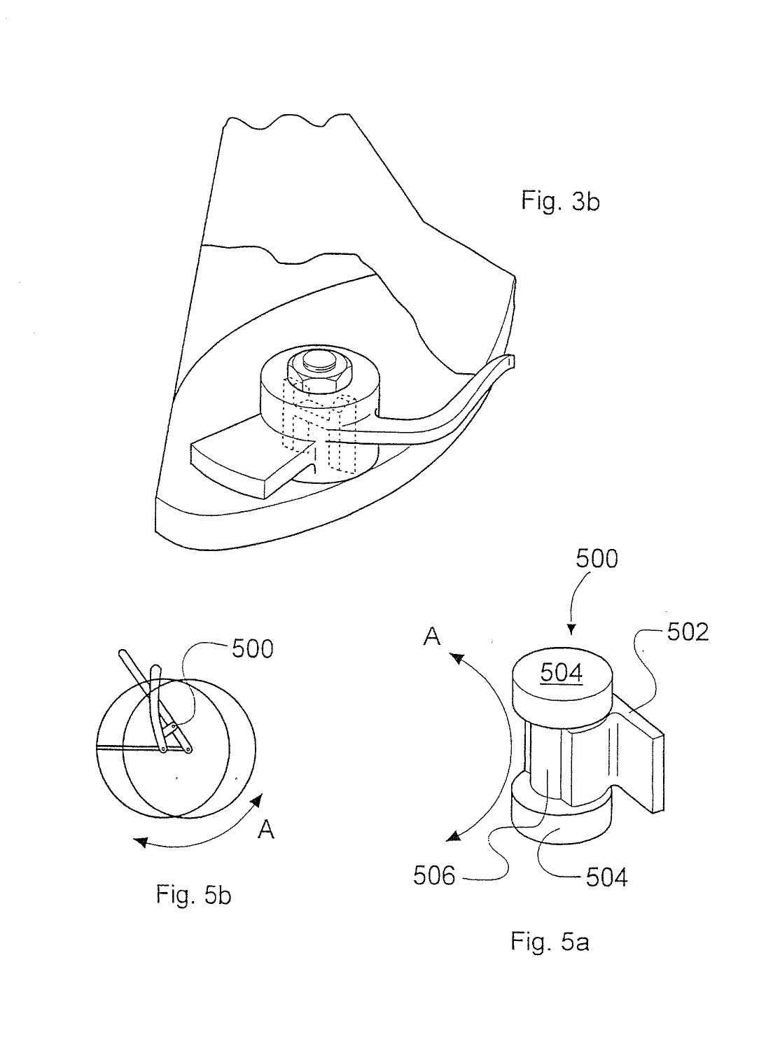

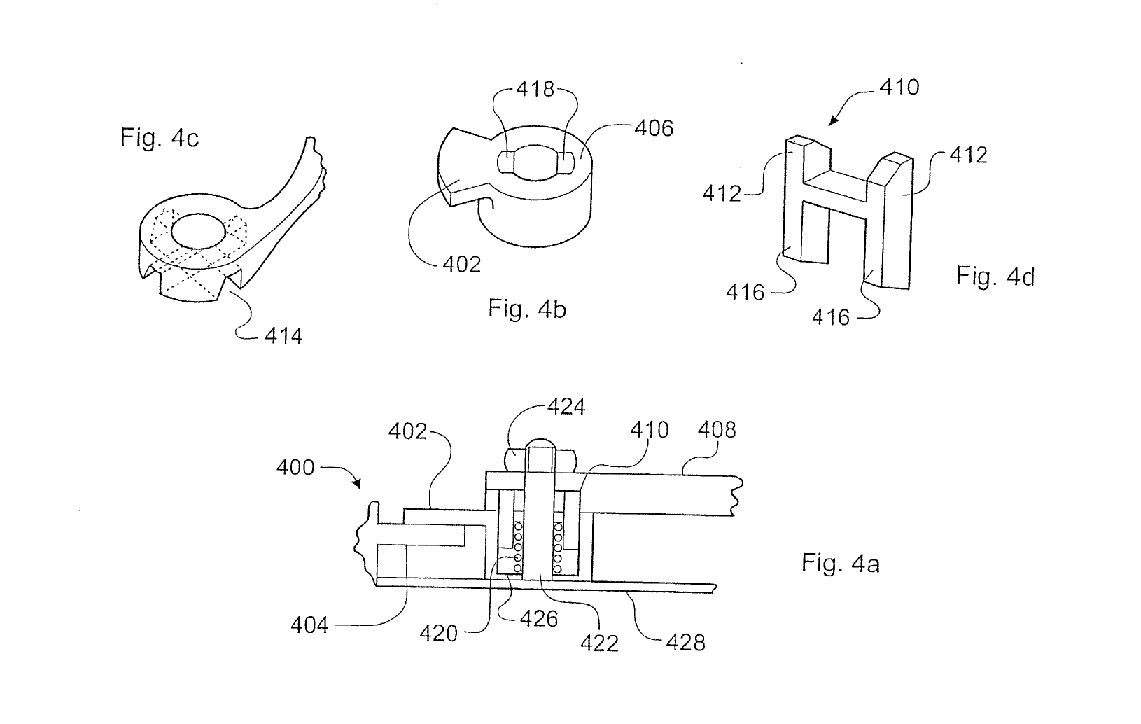

A problem with existing clamps is that they require adjustment as the clamps wear. As shown in FIGS. 4a to 4d, an improved clamp system is shown designated generally 400. The clamp includes a hinge (not shown) and a pair of taper plates 402, 404 which lock together in the unfolded position to lock the hinge in that position. The taper of the plates is not shown but it will be appreciated that as a result of the taper, any wear in the plates can be compensated by advancing the plates further into engagement. Taper plate 404 is formed integrally with the remainder of the bicycle frame and taper plate 402 is moveably mounted comprising an extension of a lug 406 shown in FIG. 4b. The lug 406, for example a butterfly lug, is rotatable such that the wear plates move into engagement by rotation of the projection 402. The lug 406 is rotated by a user operable lever 408 shown in FIG. 4c. The lever 408 interlocks with the lug 406 via an H-shaped boss 410 shown in FIG. 4d. The boss 410 includes a pair of portions 412 received in corresponding recesses 414 in the lever 408. The boss 410 further includes a pair of elements 416 received in cooperating recesses 418 in the lug 406. The boss 410 is biased upwardly into engagement with the lever 408 by spring means 420 provided around a central shaft 422 on which the lever 408 pivots, held in place by a nut 424. The base of the spring means 420 is located on a bottom face 426 of the lug 406 and the arrangement as a whole is assembled on a bottom section 428.

The portions 412 of the boss which engage the lever 408 include tapered faces which cooperate with tapered faces in the recesses 414 of the lever.

As the lever is rotated and the taper plates 402, 404 move into engagement, increased force must be exerted by the user on the lever 408. Once this force exceeds the upward bias provided by spring means 420 on the boss 410, the taper engagement between the elements 412 of the boss and the recesses 414 of the lever simply pushes the boss down against the spring as the lever is further rotated until the boss moves out of engagement with the lever. Accordingly, once a suitable lock is achieved between the taper plates 402, 404, further rotation of the lever is not required. If it is desired to unlock the taper plates 402, 404, the lever 408 is rotated in the opposite direction until the boss 410 is sprung back into engagement with the lever allowing the taper plates 402, 404 to be unlocked. Advantageously, this configuration means that the locking point and releasing point coincide, simplifying operation and minimizing user time. It will be noted that the lever can have more than one pair of recesses 414 allowing the boss to be engaged at a corresponding number of different orientations of the lever.

As a result, a wear compensating clamp is provided, the resilient bias of the spring being selected such that when a desired clamping force is exceeded, the lever is disengaged from the relevant taper plate. Again, because of the tapering of the plates, even though the plates may wear, this is automatically compensated for.

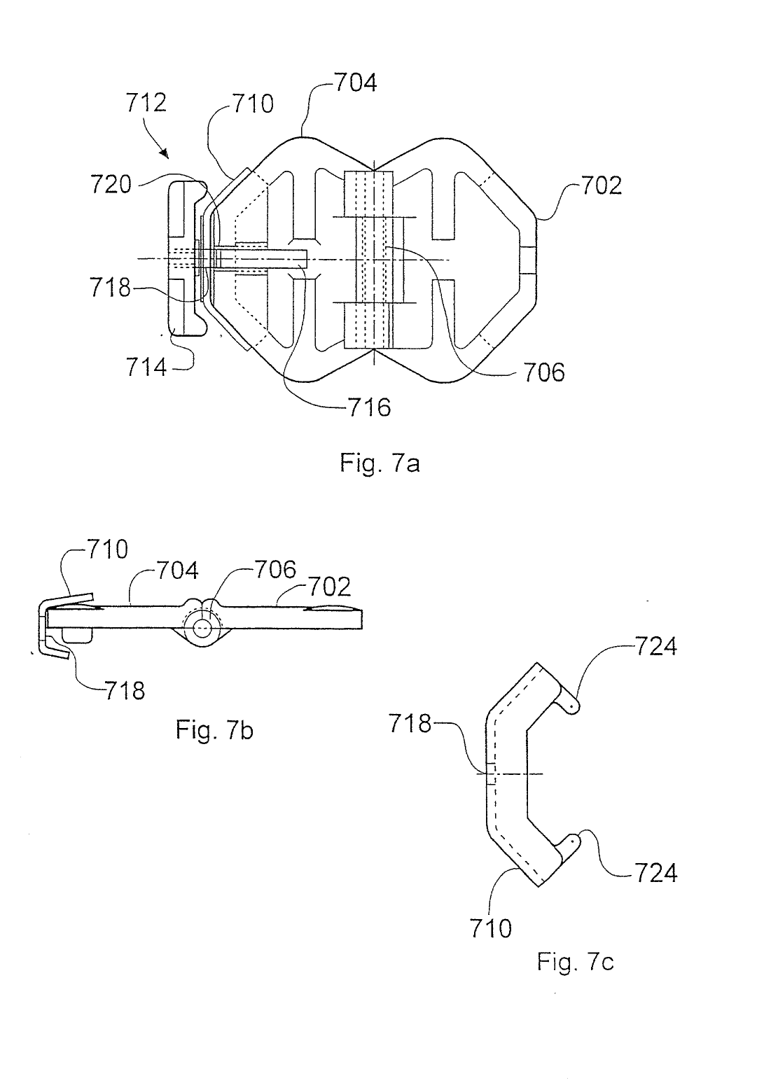

In an alternative preferred embodiment as shown in FIG. 7a, an alternative form of center hinge is provided in place of the center hinge 101 as shown in FIG. 1. The hinge is designated generally as 700 in FIG. 7a and comprises a front hinge portion 702 and rear hinge portion 704 joined by a hinge pin 706. The hinge portions and hinge pin are dimensioned and of suitable metal or alloy material to provide stiff lateral bracing to resist welding-induced distortion as well as torsional or twisting forces in use. The rear faces of each of the hinge portions preferably have recesses for securely and accurately receiving the respective halves of the bicycle assembly.

The hinge portions are held in the folded position by a locking collar preferably made of stainless steel. The locking operation is carried out using a spinner 712 including a spinner heard 714 and threaded shank 716. The shank 716 passes through an aperture 718 in the locking collar and an aperture 720 in the rear hinge portion 704. A nylon end piece (not shown) or other suitable means are provided at the end of the shank 716 to prevent further rotation of the spinner 712 when the locking collar 710 disengages. As can be seen in FIG. 7b, the locking collar includes front and rear flanges 722a and 722b arranged to embrace respective outer faces of the front and rear hinge portions 702, 704 when the hinge 700 is closed and angle portions 703, 705 extending around the sides of the hinge to provide lateral locking. To release the hinge, the spinner 714 is rotated. A sleeve is secured by an intereference fit on the shank 716 such that as the spinner retracts, the locking collar 710 is driven out of engagement with the hinge portion 702, 704. The locking collar 710 includes protruding tabs 724 on one of the flanges 722a, 722b which remain located on the rear hinge portion 704 when the locking collar 710 is maintained in captive alignment at all times. As can be seen in FIG. 7d, the spinner head 714 is ergonomically configured for ease of spinning. In addition, the hinge 700 as a whole is positioned angled relative to the center beam of the folding bicycle and positioned such that the spinner can be accessed in both the unfolded and folded conditions without difficulty and without risk of snagging.

Accordingly, this hinge arrangement allows a suitable stiff and strong joint to be provided which is nonetheless easily locked and unlocked. The profile of the spinner allows a good torque on initial locking and unlocking of the hinge as well as fast spinning inbetween, at the same time not presenting any snagging risk. The engagement between the spinner shank and the locking collar provides quick, repeated one handed operation, and the additional provision of locating tabs enhances the simplicity of the operation further. The profile of the locking collar provides locking against torsional forces and in particular an engagement with 80° hinge faces counteracts torsional loads as can be seen in FIG. 7b.

The adjustable system as shown in FIG. 1 ensures the comfort and correct fit of most sizes of rider to the bicycle. It involves the combination of the following elements.

The use of small side wheels, e.g. 16 inch-20 inch diameter. In the example used, 47-305 mm wheels are used to optimize the range of adjustment. Besides facilitating the luggage trolley aspects, discussed above, the use of small wheels necessitates the use of long, variable height seatposts and handlebar posts to create the range of correct saddle and handlebar positions for different sizes of riders.

The small wheels and long seatposts and handlebar posts in turn require the use of a low stepover main frame structure. This will need to be as stiff as possible since it does not benefit from the bracing given by a diamond (or triangulated) main frame structure. As such, it will be prone to flexing and therefore inefficient use of pedaling power. The main frame therefore uses a wise section beam, preferably in a light material like aluminum to avoid excessive weight.

The seatpost telescropes into the frame, being secured at the selected height by a clamp and quick release skewer, preferably as discussed above. The seatpost also has a curvature (“swan neck”), below the saddle mounting point. This gives in this example an offset of 20 mm. The seatpost can be fitted in the reverse position by rotating it through 180 degrees and refitting the saddle. This therefore alters the fore and aft position of the saddle mounting point on the seatpost—therefore of the saddle—by 40 mm.

A telescopic handlebar post is used with a wide range of height adjustment to allow the selection of the right handlebar height. The stem base is basically a tube allowing the handelbar post to be telescoped into it, being secured at the selected height by a clamp and quick release skewer. The stem base is in turn secured to the steering head like a conventional handlebar stem, i.e. by the use of a long bolt and tapered, threaded plug. The handlebar post has a swan neck curvature below the handlebar mounting point. This gives in this example an offset of 20 mm. The handlebar post can be fitted in the reverse position by rotating it through 180 degrees and refitting the handlebar levers and controls. This therefore alters the fore and aft position of the handlebars by 40 mm.

The use of a proprietary saddle provides a high level of fore and aft adjustment, in this example 50 mm.

When a non-parallel seat tube and steering head angle and handlebar stem base critically also diverging from that of the steering head, the handlebar stem base therefore imparts a forward tilt to the telescopic handlebar post. In this example, the seat tube has a notional angle of 72.25° (i.e. measured on the seatpost), the steering head effective angle is 73.5°, when using a front fork with an offset of 25 mm. The tilt of the stem base is calculated so that it alters the reach between the notional minimum heights and maximum heights of the seatpost and handlebar post by a range of between 4 cm and 5 cm. This reach dimension is calculated by measuring between the tip of a 275 mm long saddle, set in the center of its adjustment, and the back of the handlebar's center. The saddle uses a 28 mm forward offset between the center of the saddle top and the center of its adjustment range.

The reach in the example bicycle ranges from a minimum of 42/43 cm to a maximum of 47/47.5 cm. These reach values are obtained with the handlebar post and seatpost swan necks both set facing backwards. The maximum value is set which takes account of the further 4 cm adjustment in reach available by rotating the handlebar post—this is the least convenient adjustment to make and is intended for particularly long armed riders. The divergence of angles is then manipulated to create the desired range of adjustment. Further refinements to reach can be achieved by using the 5 cm saddle fore and aft adjustment and also by experimenting with handlebar post height. The values given by the example span a wide range equating to, at the minimum, a reach suitable for a child of 4 feet, 10 inches in height, and at the maximum, to a reach suitable for an adult of 6 feet, 6 inches in height. It also allows for choice of different riding positions depending on preference and national cycling cultures.

The stem base is tilted so that the distance between the saddle and the center of the handlebars (or “reach”) increases smoothly as the seatpost and handlebar post are telescoped upwards. Angles for the seat tube and head tube should lead, with a straight, i.e. non-tilting, stem base, to the reach reducing as the posts are extended but they in fact diverge in their movement. This is by virtue of the greater range of the seatpost height adjustment (maximum here for purposes of measurement of 185 mm, though it can be greater) and that of the handlebar post (maximum here of 135 mm). Therefore, the lines describe the movement of the two posts as they are telescoped across their range of adjustment overlap. This can be manipulated to create greater reach for larger riders. This effect is important since it reduces the angle of tilt required for the stem base to achieve a total of the target 4 cm to 5 cm range of total adjustment in reach. Since the handlebar post telescopes through, e.g. just 13.5 cm, without assistance from the divergence of the two posts, then this would otherwise require a very steep slope for the reach to alter so much over the 13.5 cm of adjustment. This, in turn, would create a very considerable “backhang” at the base of the stem base since the 37.5 cm non-adjusting length of the stem base/handlebar post is far greater in length than the adjusting section of 13.5 cm. With the value of 37.5 cm of non-adjusting section of the stem base and post, then any displacement of 1 cm reach on the 13.5 cm of telescopic adjustment creates displacement below it of 375/135 cm. This, in turn, leads to a large proportion of the weight of the stem base extending behind the back of the steering head.

As shown in FIG. 3, in one embodiment, an elliptical shaped cone 300 is used for the stem base to accommodate this movement of the handlebar post and the offset of the stem base and handlebar post to achieve the divergent angle. This structure also acts to brace the handle post when it is subjected to the momentum effects of hard braking. This avoids the typical flexure experienced with long regular tube section stem bases which would otherwise limit the strength of the brakes that can be used.

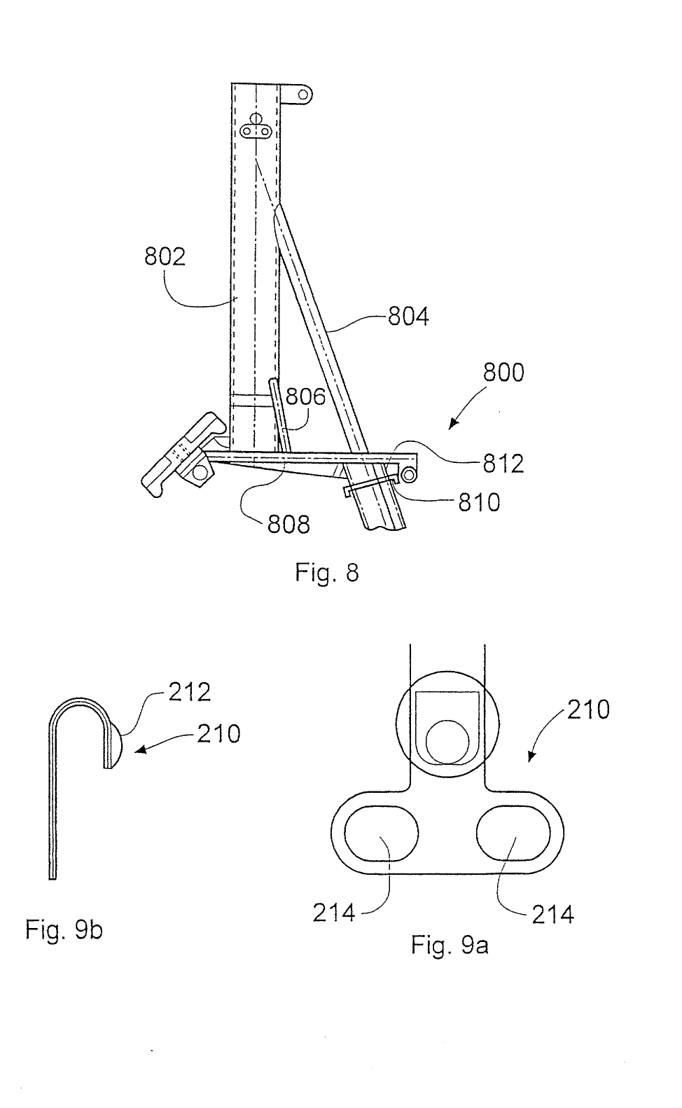

In an alternative embodiment, tubular or plate triangular struts or swaged stiffening can be used to provide bracing against rotational forces acting on the end of the stem base on braking, accelerating or when the cyclist is placing additional weight on the handlebars, for example when climbing. This is demonstrated in FIG. 8, which shows stem base 800, handlebar post 802 offset from the stem base to allow divergent angles to be achieved, bracing post 804 and bracing web 806 extending between the handlebar post 802 and a base plate 808.

The stem base 800 is locked down onto the lock nut 810 on the head bearings via a collar 812. This compensates for the rotational movement usually caused because of the engagement of the stem base with the dedicated engagement face of the lock nut 810 which comprises a narrow ring together with the play between the stem tube that extends down into the head bearing tube. This movement is a particular problem in folding bikes where the moment at this point is greatly increased by the length of the handlebars. The collar 812 engages a wider annular face of the lock nut 810 to eliminate this rotational movement. Preferably, there is provided an O-ring seal below the clamp point to prevent water ingress.

The reach therefore increases as the handlebar post and seatpost are set at higher heights for larger riders and decreases when these posts are set at lower heights for shorter riders. The inter-related movement of the different elements of the adjustability feature allows the rider to select the correct riding and pedaling position whereby maximum pedaling torque will be maintained. Further adjustments are then made to the handlebar post height or swan neck position to set the correct reach.

The parameters governing these values are small. Firstly, seat tube angle changes will manipulate the reach. There is a benign effect with this system that if you choose the right notional angle (measured on the seat tube), then as the saddle is moved forward (and the swan neck reversed) and the seat post drops to accommodate shorter riders, the true seat tube angle will gently become more vertical, following the classic view that seat tube angles should be more vertical for shorter riders. This will then produce a balanced set of values for reach and for saddle height/pedaling angle for the child of 4 feet, 10 inches in height through to the adult of 6 feet, 6 inches in height.

A major constraint in the system is the need for the bicycle to offer good handling and steering regardless of weight or size of the rider. The approach used is to select values for the wheelbase, head angles and seat tube angles which offer steering which balances the need for the bicycle to be responsive and precise in its steering at low speeds yet to track well at higher speeds. In selecting values, the approach is to choose those values which are not over sensitive —i.e. so that characteristics do not, as far as possible, alter rapidly with small angle or dimensional changes. Less sensitive values offer the best chance of retaining good handling and steering across the range of rider adjustments. The skilled person can derive these values with routine techniques.

It will be appreciated that the embodiments discussed above can be combined and interchanged as appropriate. It will further be appreciated that various of the embodiments can be equally applied in relation to standard, rigid bicycles. Yet, further the explicit teachings set out above for optimum dimensions, angles and configuration of the specific embodiment described can be applied to different sizes, configuration and types of bicycle with only routine technical work based on those teachings. For example, dedicated luggage bags with rigid plastic bases with cut outs in the base can positively locate the bag on the luggage carrier. In that embodiment, the plastic base contains retractable elasticized luggage straps to secure the bags to the carrier. For safety and convenient use, the straps retract inside the base of the bag once the bag is removed from the carrier.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A bicycle adjustable in size to suit user size, the bicycle including a handlebar mount and seat mount disposed at angles divergent to one another, at least one of the handlebar mount and seat mount being arranged such that the handlebar and/or seat is adjustable in height, the bicycle further including a front fork mount disposed at an angle to the handlebar mount.

2. A bicycle as claimed in claim 1, in which the handlebar mount and seat mount are both arranged such that the handlebars and seat are adjustable in height.

3. A bicycle as claimed in claim 2, in which the bicycle is foldable.

4. A bicycle as claimed in claim 1, further including a seat and handlebars mounted to the seat mount and handlebar mount, respectively, via posts having upper portions angled to the angles of the seat mount and handlebar mount, respectively.

5. A bicycle as claimed in claim 1, in which the seat mount is disposed at an effective angle to the horizontal in the range 72° to 80°.

6. A bicycle as claimed in claim 1, in which the handlebar mount angle to the horizontal is preferably in the range 73° to 74.5°.

7. A folding bicycle comprising a first frame part bearing a front wheel and a second frame part bearing a rear wheel, wherein the frame parts are foldable to fold the front and rear wheels side by side in a folded condition, with at least one wheel freely movable and with handlebars positioned substantially above the front and rear wheels, a load carrying platform being mounted above the wheels in the folded condition, the bicycle being arranged such that in the folded condition a trolley configuration is provided and including a releasable lock for locking the frame parts together in the folded condition so as to provide a secure locking of the frame in the trolley configuration to resist components of a load when loaded.

8. A bicycle as claimed in claim 7, further comprising male and female parts on the frame parts which snap fit together when the bicycle is in the folded condition, the male and female parts comprising cooperating formations arranged to retain the male and female parts in engagement when the load is applied.

9. A clip for a folding bicycles comprising male and female parts arranged for snap fit connection when urged together in a first direction and including cooperating formations to resist disengagement when a load is applied in a second direction.

10. A folding bicycle including at least one hinge between hinged parts and a releasable clamp for clamping the hinge in an open position, the clamp comprising cooperating tapered locking plates, a resiliently biased locking plate moving element and a user operable locking member, the locking member engaging the moving element to move the locking plates into engagement with one another, and the moving element being configured to disengage the locking member when a locking plate engagement force exceeds a resilient bias.

11. A folding bicycle as claimed in claim 10, in which the hinge is found on at least one of a handlebar post and a beam between front and rear wheels.

12. A clamp for a folding bicycle comprising cooperating tapered locking plates, a resiliently biased locking plate moving element and a user operable locking member, the locking member engaging the moving element to move the locking plates into engagement with one another, and the moving element being configured to disengage the locking member when a locking plate engagement force exceeds a resilient bias.

13. A folding bicycle comprising:
front and rear frame parts each bearing a respective front and rear wheel and hinged relative to one another;
a moveably mounted saddle;
moveably mounted handlebars;
a handlebar post hinged relative to remaining elements of the bicycle;
in which the bicycle is folded following a predetermined fold sequence, and relevant parts of the bicycle are marked in such a manner as to indicate a relevant fold sequence.

14. A seat or handlebar post for an adjustable bicycle arranged to be received in a seat or handlebar post mount, respectively, in a telescoping fit and including a plurality of markings indicating different possible post heights.

15. A seat or handlebar post as claimed in claim 14, including a formation arranged to cooperate with a corresponding formation on a post mount in which the markings are provided on the formation.

16. A seat or handlebar post as claimed in claims 14, in which the markings follow a user memorable sequence to aid in memorizing a desired position.

17. A seat or handlebar post for an adjustable bicycle arranged to be received in a seat or handlebar post mount, respectively, in a telescoping fit, in which the post has a formation arranged to cooperate with a corresponding formation on the post mount to align the post relative to the post mount.

18. A post as claimed in claim 17, in which one of the formations comprises a groove and the other of the formations comprises a leaf spring detent.

19. A post as claimed in claim 18 in which the groove is arranged to cooperate with a projection on the post mount.

20. A post as claimed in claim 18 in which the post is reversible.

21. A handlebar post as claimed in claim 17 in which the formation of the post cooperates with the formation on the post mount to align a handlebar in each of a use position and a fold away position.

22. A folding bicycle including a main beam having a hinge, the hinge comprising first and second hinge parts, a clamp arranged to releasably clamp the hinge parts in a clamped configuration, and user operable drive for driving the clamp between a clamped and unclamped configuration.

23. A bicycle comprising a handlebar post including a projection tube arranged to be received in the handlebar post mount and secured by a locking nut, further comprising an intermediate collar for positioning between the handlebar post and locking nut to provide secure attachment therebetween.

24. A bicycle including a carrier for carrying articles and an elastic material securing strap, the strap being secured at one end remote from the carrier and being releasably secured at the other end at or adjacent a first end of the carrier, the strap further passing over a bearing at or adjacent to a second end of the carrier.

25. A bicycle as claimed in claim 24, in which the bearing comprises one or more rollers.

26. A bicycle as claimed in claim 25, in which the rollers comprise front and rear rollers between which the strap passes.

27. A bicycle comprising a carrier including a carrying surface and a rigid securing element, the securing element being shaped to form a tortuous path around at least two securing points on the bicycle to cantilever the carrying surface, a releasable lock being provided at at least one of the securing points allowing the carrier to be moved between a use position and a stowed position.

28. A bicycle as claimed in claim 5, in which the effective angle to the horizontal is in the range of 73.8° to 76.8°.

29. A bicycle as claimed in claim 28, in which the effective angle to the horizontal is 75.25°.

30. A bicycle as claimed in claim 6, in which the handlebar mount angle to the horizontal is in the range of 73.25° to 74°.

31. A bicycle as claimed in claim 30, in which the handlebar mount angle to the horizontal is 73.5°.
